(19) United States
(12) Patent Application Publication
(10) Pub. No.: US 2019/0108242 A1
(43) Pub. Date: Apr. 11, 2019

(54) SEARCH METHOD AND PROCESSING DEVICE

(71) Applicant: Alibaba Group Holding Limited, Grand Cayman (KY)

(72) Inventors: Ruitao Liu, Hangzhou (CN); Yu Liu, Hangzhou (CN)

(21) Appl. No.: 16/156,998

(22) Filed: Oct. 10, 2018

(30) Foreign Application Priority Data
Oct. 10, 2017 (CN) 201710936315.0

(51) Int. Cl. G06F 17/30; G06K 9/46; G06F 17/27; G06K 9/62

(52) U.S. Cl. CPC G06F 17/30271; G06K 9/46; G06F 17/2785; G06F 17/3028; G06K 9/6256; G06F 17/30256; G06F 17/30253; G06K 9/6215

(57) ABSTRACT

A method including extracting an image feature vector of a target image, wherein the image feature vector is used for representing image content of the target image; and determining, in the same vector space, a text corresponding to the target image according to a correlation between the image feature vector and a text feature vector of the text, wherein the text feature vector is used for representing semantics of the text. The method solves the problems of low efficiency and high requirements on the system processing capability in the conventional techniques, thereby achieving a technical effect of easily and accurately implementing image tagging.

### CROSS REFERENCE TO RELATED PATENT APPLICATIONS

This application claims priority to and is a continuation of Chinese Patent Application No. 201710936315.0 filed on 10 Oct. 2017 and entitled “SEARCH METHOD AND PROCESSING DEVICE,” which is incorporated herein by reference in its entirety.

### TECHNICAL FIELD

The present disclosure relates to the field of Internet technologies, and more particularly to search methods and corresponding processing devices.

### BACKGROUND

With the constant development of technologies such as Internet and e-commerce, the demands for image data continue to grow. How to analyze and utilize image data more effectively has a great influence on e-commerce. In the process of processing image data, recommending tags for images allows for more effective image clustering, image classification, image retrieval, and so on. Therefore, the demand of recommending tags for image data is growing.

For example, a user A wants to search for a product by using an image. In this case, if the image may be tagged automatically, a category keyword and an attribute keyword related to the image may be recommended automatically after the user uploads the image. Alternatively, in other scenarios where image data exists, a text (for example, a tag) may be recommended automatically for an image without manual classification and tagging.

Currently, there is no effective solution as to how to easily and efficiently tag an image.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

The present disclosure provides search methods and corresponding processing devices to easily and efficiently tag an image.

The present disclosure provides a search method and a processing device, which are implemented as follows:

A search method, including:

extracting an image feature vector of a target image, wherein the image feature vector is used for representing image content of the target image; and

determining, in the same vector space, a tag corresponding to the target image according to a correlation between the image feature vector and a text feature vector of the tag, wherein the text feature vector is used for representing semantics of the tag.

A processing device, including one or more processors and one or more memories configured to store computer-readable instructions executable by the one or more processor, wherein when executing the computer-readable instructions, the processors implements the following acts:

extracting an image feature vector of a target image, wherein the image feature vector is used for representing image content of the target image; and

determining, in the same vector space, a tag corresponding to the target image according to a correlation between the image feature vector and a text feature vector of the tag, wherein the text feature vector is used for representing semantics of the tag.

A search method, including:

extracting an image feature of a target image, wherein the image feature is used for representing image content of the target image; and

determining, in the same vector space, a text corresponding to the target image according to a correlation between the image feature and a text feature of the text, wherein the text feature is used for representing semantics of the text.

One or more memories storing thereon computer-readable instructions that, when executed by the one or more processors, cause the one or more processors to perform the steps of the above method.

The image tag determining method and the processing device provided by the present disclosure search for a text based on an image to directly search for and determine recommended texts based on an input target image without adding an image matching operation during matching, and obtain a corresponding text through matching according to a correlation between an image feature vector and a text feature vector. The method solves the problems of low efficiency and high requirements on the system processing capability in existing text recommendation methods, thereby achieving a technical effect of easily and accurately implementing image tagging.

### BRIEF DESCRIPTION OF THE DRAWINGS

To describe the technical solutions in the example embodiments of the present disclosure more clearly, the drawings used in the example embodiments are briefly introduced. The drawings in the following description merely represent some example embodiments of the present disclosure, and those of ordinary skill in the art may further obtain other drawings according to these drawings without creative efforts.

FIG. 1 is a method flowchart of an example embodiment of a search method according to the present disclosure;

FIG. 2 is a schematic diagram of establishing an image coding model and a tag coding model according to the present disclosure;

FIG. 3 is a method flowchart of another example embodiment of a search method according to the present disclosure;

FIG. 4 is a schematic diagram of automatic image tagging according to the present disclosure;

FIG. 5 is a schematic diagram of searching for a poem based on an image according to the present disclosure;

FIG. 6 is a schematic architectural diagram of a server according to the present disclosure; and

FIG. 7 is a structural block diagram of a search apparatus according to the present disclosure.

### DETAILED DESCRIPTION

To enable those skilled in the art to better understand the technical solutions of the present disclosure, the technical solutions in the example embodiments of the present disclosure will be described below with reference to the accompanying drawings in the example embodiments of the present disclosure. The described example embodiments merely represent some rather than all embodiments of the present disclosure. All other embodiments obtained by those of ordinary skill in the art based on the example embodiments of the present disclosure shall fall within the protection scope of the present disclosure.

Currently, some methods for recommending a text for an image already exist. For example, a model for searching for an image based on an image is trained, an image feature vector is generated for each image, and a higher similarity between the image feature vectors of any two images indicates a higher similarity between the two images. Based on this principle, existing search methods are generally to collect an image set and control images in the image set to cover as much as possible the entire application scenario. Then, one or more images similar to an image input by a user may be determined from the image set by using a search-match manner that is based on image feature vectors. Then, texts of the one or more images are used as a text set, and one or more texts having a relatively high confidence are determined from the text set as texts recommended for the image.

Such search methods are complex to implement, because an image set covering the entire application scenario needs to be maintained, the accuracy of text recommendation relies on the size of the image set and the precision of texts carried in the image set, and the texts often need to be annotated manually.

In view of the problems of the above-mentioned text recommendation method for searching for an image based on an image, it is considered that a manner of searching for a text based on an image may be used, to directly search for and determine recommended texts based on an input target image without adding an image matching operation during matching, and a corresponding text may be directly obtained through matching by using the target image, that is, a text may be recommended for the target image by using the manner of searching for a text based on an image.

The text may be a short tag, a long tag, particular text content, or the like. The specific content form of the text is not limited in the present disclosure and may be selected according to actual requirements. For example, if an image is uploaded in an e-commerce scenario, the text may be a short tag; or in a system for matching a poem with an image, the text may be a poem. In other words, different text content types may be selected depending on actual application scenarios.

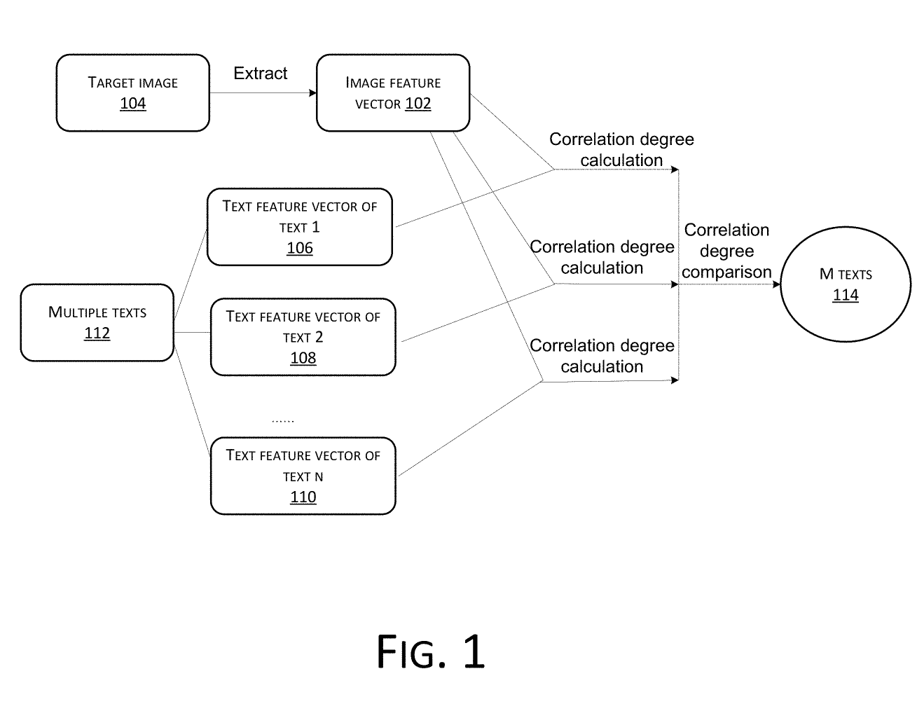

It is considered that features of images and features of texts may be extracted, followed by calculating correlations between the image and texts in a tag set according to the extracted features, and determining a text of a target image based on the values of the correlations. Based on this, this example embodiment provides a search method, as shown in FIG. 1, wherein an image feature vector 102 for representing image content of a target image 104 is extracted from the target image 104. A text feature vector for representing semantics of a text is extracted from the text. For example, a text feature vector of text 1 106, a text feature vector of text 2 108, . . . , and a text feature vector of text N 110 are extracted from multiple texts 112 respectively, where N may be any integer. Statistics are conducted based on a correlation degree calculation between the image feature vector 102 and each of the text feature vectors, such as the text feature vector of text 1 106, the text feature vector of text 2, and the text feature vector of text N, respectively. Based on the correlation degree comparison, the M texts 114 are determined as texts of the target image 104. The M texts may be the texts with the top correlation degrees. M may be any integer from 1 to N.

That is, respective encoding is performed to convert data of a text modality and an image modality into feature vectors of features in the same space, then correlations between texts and the image are measured by using distances between the features, and the text corresponding to a high correlation is used as the text of the target image.

In an implementation manner, the image may be uploaded by using a client terminal. The client terminal may be a terminal device or software operated or used by the user. For example, the client terminal may be a terminal device such as a smart phone, a tablet computer, a notebook computer, a desktop computer, a smart watch, or other wearable devices. Certainly, the client terminal may also be software that may run on the terminal device, for example, Taobao™ mobile, Alipay™, a browser or other application software.

In an implementation manner, considering the processing speed in actual applications, the text feature vector of each text may be extracted in advance, so that after the target image is acquired, only the image feature vector of the target image needs to be extracted, and the text feature vector of the text does not need to be extracted, thereby avoiding repeated calculation and improving the processing speed and efficiency.

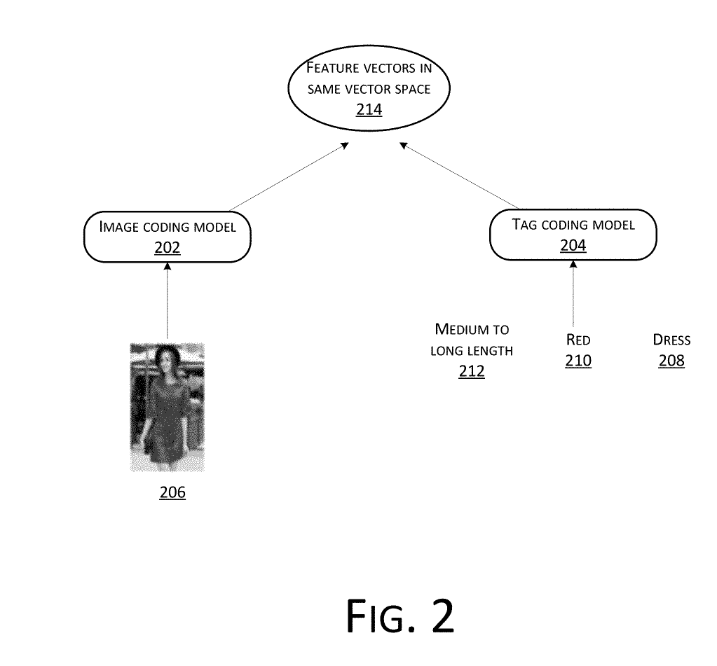

As shown in FIG. 2, the text determined for the target image may be selected by, but not limited to, the following manners:

1) using one or more texts as texts corresponding to the target image, wherein a correlation between a text feature vector of each of the one or more texts and the image feature vector of the target image is greater than a preset threshold;

For example, the preset threshold is 0.7. In this case, if correlations between text feature vectors of one or more texts and the image feature vector of the target image are greater than 0.7, the texts may be used as texts determined for the target image.

2) using a predetermined number of texts as texts of the target image, wherein correlations between text feature vectors of the predetermined number of texts and the image feature vector of the target image rank on the top.

For example, the predetermined number is 4. In this case, the texts may be sorted based on the values of the correlations between the text feature vectors of the texts and the image feature vector of the target image, and the four texts corresponding to the top ranked four correlations are used as texts determined for the target image.

However, it should be noted that the above-mentioned method for selecting the text determined for the target image is merely a schematic description, and in actual implementation manners, other determining policies may also be used. For example, texts corresponding a preset number of top ranked correlations that exceed a preset threshold may be used as the determined texts. The specific manner may be selected according to actual requirements and is not specifically limited in the present disclosure.

To easily and efficiently acquire the image feature vector of the target image and the text feature vector of the text, a coding model may be obtained through training to extract the image feature vector and the text feature vector.

As shown in FIG. 2, using the text being a tag as an example, an image coding model 202 and a tag coding model 204 may be established, and the image feature vector and the text feature vector may be extracted by using the established image coding model 202 and tag coding model 204.

In an implementation manner, the coding model may be established in the following manner:

Step A: A search text of a user in a target scenario (for example, search engine or e-commerce) and image data clicked based on the search text are acquired. A large amount of image-multi-tag data may be obtained based on the behavior data.

The search text of the user and the image data clicked based on the search text may be historical search and access logs from the target scenario.

Step B: Segmentation and part-of-speech analysis are performed on the acquired search text.

Step C: Characters such as digits, punctuations, and gibberish are removed from the text while keeping visual separable words (for example, nouns, verbs, and adjectives). The words may be used as tags.

Step D: Deduplication processing is performed on the image data clicked based on the search text.

Step E: Tags in a tag set that have similar meanings are merged, and some tags having no practical meaning and tags that cannot be recognized visually (for example, development and problem) are removed.

Step F: Considering that an <image single-tag> dataset is more conducive to network convergence than an <image multi-tag> dataset, <image multi-tag> may be converted into <image single-tag> pairs.

For example, assuming that a multi-tag pair is <image, tag1:tag2:tag3>, it may be converted into three single-tag pairs <image tag1>, <image tag2>, and <image tag3>. During training, in each triplet pair, one image corresponds only to one positive sample tag.

Step G: Training is performed by using the plurality of single-tag pairs acquired, to obtain an image coding model 202 for extracting image feature vectors from images and a tag coding model 204 for extracting text feature vectors from tags, and an image feature vector and a text feature vector in the same image tag pair are made to be as correlated as possible.

For example, the image coding model 202 may be a neural network model abstracted by using ResNet-152 as an image feature vector. An original image is uniformly normalized to a preset pixel value (for example, 224×224 pixels) serving as an input, and then a feature from the pool 5 layer is used as a network output, wherein an output feature vector has a length of 2048. Based on the neural network model, transfer learning is performed by using nonlinear transformation, to obtain a final feature vector that may reflect the image content. As shown in FIG. 2, the image 206 in FIG. 2 may be converted by the image coding model 202 into a feature vector that may reflect the image content.

The tag coding model 204 may be converting each tag into a vector by using one-hot encoding. Considering that a one-hot encoded vector is generally a sparse long vector, and to facilitate processing, the one-hot encoded vector is converted at an Embedding Layer into a low-dimensional real-valued dense vector, and the formed vector sequence is used as the text feature vector corresponding to the tag. For a text network, a two-layer fully connected structure may be used, and other nonlinear computing layers may be added to increase the expression ability of the text feature vector, to obtain text feature vectors of N tags corresponding to an image. That is, the tag is finally converted into a fixed-length real vector. For example, tag “dress” 208, tag “red” 210, tag “medium to long length” 212 in FIG. 2 are converted into a text feature vector respectively by using the tag coding model 204, for comparison with the image feature vector, wherein the text feature vector may be used to reflect original semantics.

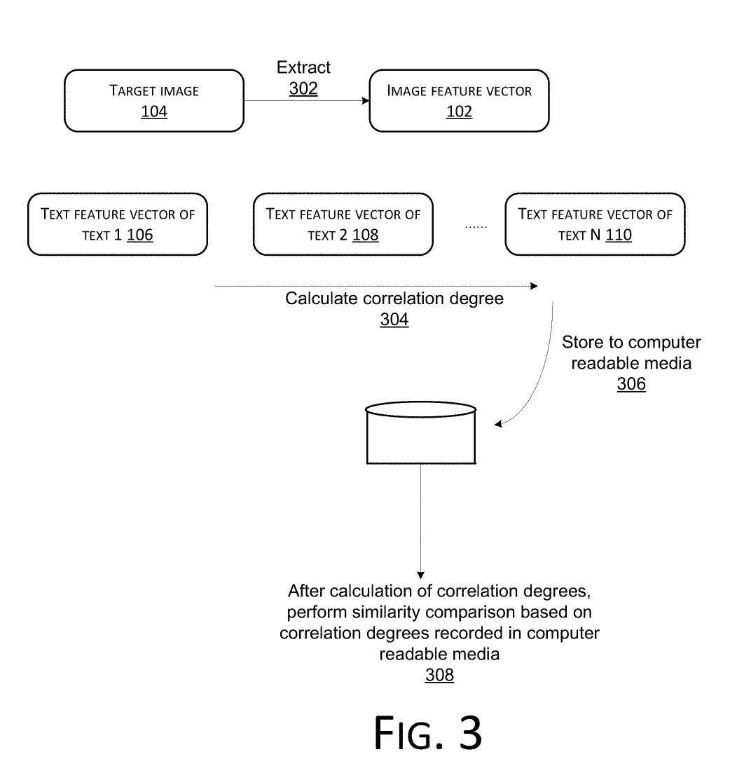

In an implementation manner, considering that simultaneous comparison of a plurality of tags requires a computer to have a high processing speed and imposes high requirements on the processing capability of a processor, as shown in FIG. 3, the following acts are performed.

At 302, the image feature vector 102 is extracted from the target image 104.

At 304, the correlation degrees are calculated.

A correlation between the image feature vector 302 and the text feature vector of each of the plurality of tags, such as the text feature vector of text 1 106, the text feature vector of text 2 108, . . . , the text feature vector of text N 110, may be determined one by one, wherein N may be any integer.

After all the correlations are determined, at 306, the correlation calculation results are stored in computer readable media such as a hard disk and do not need to be all stored in internal memory. For example, the correlation calculation results may be stored in the computer readable media one or by one.

At 308, after calculation of the correlations between all tags in the tag set and the image feature vector, similarity comparison such as similarity-based sorting or similarity determining is performed, to determine one or more tag texts that may be used as the tag of the target image.

In an alternative implementation, the correlation degrees may be calculated in parallel, and the correlation degrees may be stored in the computer readable media in parallel as well.

To determine the correlation between the text feature vector and the image feature vector, a Euclidean distance may be used for representation. For example, both the text feature vector and the image feature vector may be represented by using vectors. That is, in the same vector space, a correlation between two feature vectors may be determined by determining through comparison a Euclidean distance between the two feature vectors.

For example, images and texts may be mapped to the same feature space, so that feature vectors of the images and the texts are in the same vector space 214 as shown in FIG. 2. In this way, a text feature vector and an image feature vector that have a high correlation may be controlled to be close to each other within the space, and a text feature vector and an image feature vector that have a low correlation may be controlled to be away from each other. Therefore, the correlation between the image and the text may be determined by calculating the text feature vector and the image feature vector.

For example, the matching degree between the text feature vector and the image feature vector may be represented by a Euclidean distance between the two vectors. A smaller value of the Euclidean distance calculated based on the two vectors may indicate a higher matching degree between the two vectors; on the contrary, a larger value of the Euclidean distance calculated based on the two vectors may indicate a lower matching degree between the two vectors.

In an implementation manner, in the same vector space, the Euclidean distance between the text feature vector and the image feature vector may be calculated. A smaller Euclidean distance indicates a higher correlation between the two, and a larger Euclidean distance indicates a lower correlation between the two. Therefore, during model training, a small Euclidean distance may be used as an objective of training, to obtain a final coding model. Correspondingly, during correlation determining, the correlations between the image and the texts may be determined based on the Euclidean distances, so as to select the text that is more correlated to the image.

In the foregoing description, only the Euclidean distance is used to measure the correlation between the image feature vector and the text feature vector. In actual implementation manners, the correlation between the image feature vector and the text feature vector may also be determined in other manners such as a cosine distance and a Manhattan distance. In addition, in some cases, the correlation may be a numerical value, or may not be a numerical value. For example, the correlation may be only a character representation of the degree or trend. In this case, the content of the character representation may be quantized into a particular value by using a preset rule. Then, the correlation between the two vectors may subsequently be determined by using the quantized value. For example, a value of a certain dimension may be “medium”. In this case, the character may be quantized into a binary or hexadecimal value of its ASCII code. The matching degree between the two vectors in the example embodiments of the present disclosure is not limited to the foregoing.

Considering that sometimes repetitive texts exist among the obtained texts or completely irrelevant texts are determined, and to improve the accuracy of text determining, incorrect texts may further be removed or deduplication processing may further be performed on the texts after statistics are collected about the correlation between the image feature vector and the text feature vector to determine the text corresponding to the target image, so as to make the finally obtained text more accurate.

In an implementation manner, in the tag determining process, for the manner of performing similarity-based sorting and selecting the first N tags as the determined tags, tagging with tags that belong to the same attribute is inevitable. For example, for an image of a “bowl”, tags having a relatively high correlation may include “bowl” and “pot”, but include no tag related to color or style because none of color and style tags ranks on the top. In this case, according to this manner, tags corresponding to several correlations that rank on the top may be directly pushed as the determined tags; or a rule may be set, to determine several tag categories and select a tag corresponding to the highest correlation under each category as the determined tag, for example, select one tag for the product type, one tag for color, one tag for style, and so on. The specific policy may be selected according to actual requirements and is not limited in the present disclosure.

For example, if it is determined that correlations ranked first and second are a red correlation 0.8 and a purple correlation 0.7, red and purple may both be used as recommended tags when a set policy is to use the top ranked several tags as recommended tags, or red may be used as a recommended tag when a set policy is to select one tag, for example, select only one color tag, for each category, because the red correlation is higher than the purple correlation.

In the above example embodiment, data from the text modality and the image modality is converted into feature vectors of features in the same space by using respective coding models, then correlations between tags and the image are measured by using distances between the feature vectors, and the tag corresponding to a high correlation is used as the text determined for the image.

However, it should be noted that the manner introduced in the above example embodiment is to map the image and the text to the same vector space, so that correlation matching may be directly performed between the image and the text. The above example embodiment is described by using an example in which this manner is applied to the method of searching for a text based on an image. That is, an image is given, and the image is tagged or description information or related text information or the like is generated for the image. In actual implementation manners, this manner may also be applied to the method of searching for an image based on a text, that is, a text is given, and a matching image is obtained through search. The processing manner and concept of searching for an image based on a text is similar to those of searching for a text based on an image, and the details will not be repeated here.

The above-mentioned search method is described below with reference to several specific scenarios. However, it should be noted that the specific scenarios are for better describing the present disclosure only, and do not constitute any improper limitation to the present disclosure.

1) Post a Product on an e-Commerce Website

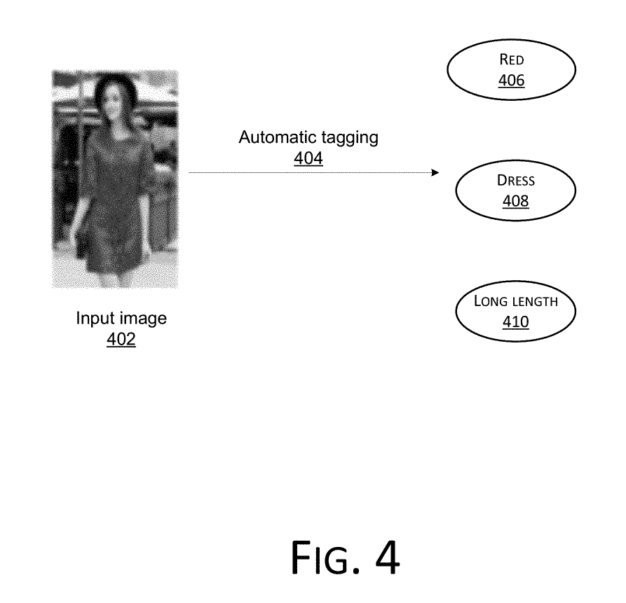

As shown in FIG. 4, a user A intends to sell a second-hand dress. After taking an image of the dress, at 402, the user inputs the image to an e-commerce website platform. The user generally needs to set a tag for the image by himself/herself, for example, enter “long length,” “red,” “dress” as a tag of the image. This inevitably increases user operations.

Thus, at 404, automatic tagging is performed.

Automatic tagging may be implemented by using the above image tag determining method of the present disclosure. After the user A uploads the image, a back-end system may automatically identify the image and tag the image. By means of the above method, an image feature vector of the uploaded image may be extracted, and then correlation calculation is performed on the extracted image feature vector and pre-extracted text feature vectors of a plurality of tags, so as to obtain a correlation between the image feature vector and each tag text. Then, a tag is determined for the uploaded image based on the values of the correlations, and tagging is automatically performed, thereby reducing user operations and improving user experience.

As shown in FIG. 4, the tags such as “red”406, “dress” 408, and “long length” 410 are automatically obtained.

2) Album

By means of the above method, after a photograph is taken, downloaded from the Internet, or stored to a cloud album or mobile phone album, an image feature vector of the uploaded photograph may be extracted, and then correlation calculation is performed on the extracted image feature vector and pre-extracted text feature vectors of a plurality of tags, so as to obtain a correlation between the image feature vector and each tag text. Then, a tag is determined for the uploaded photograph based on the values of the correlations, and tagging is automatically performed.

After tagging, photographs may be classified more conveniently, and subsequently when a target image is searched for in the album, the target image may be found more quickly.

3) Search for a Product by Using an Image

For example, in a search mode, a user needs to upload an image, based on which related or similar products may be found through search. In this case, by means of the above method, after the user uploads the image, an image feature vector of the uploaded image may be extracted, and then correlation calculation is performed on the extracted image feature vector and pre-extracted text feature vectors of a plurality of tags, so as to obtain a correlation between the image feature vector and each tag text. Then, a tag is determined for the uploaded image based on the values of the correlations. After the image is tagged, a search may be made by using the tag, thereby effectively improving the search accuracy and the recall rate.

4) Search for a Poem by Using an Image

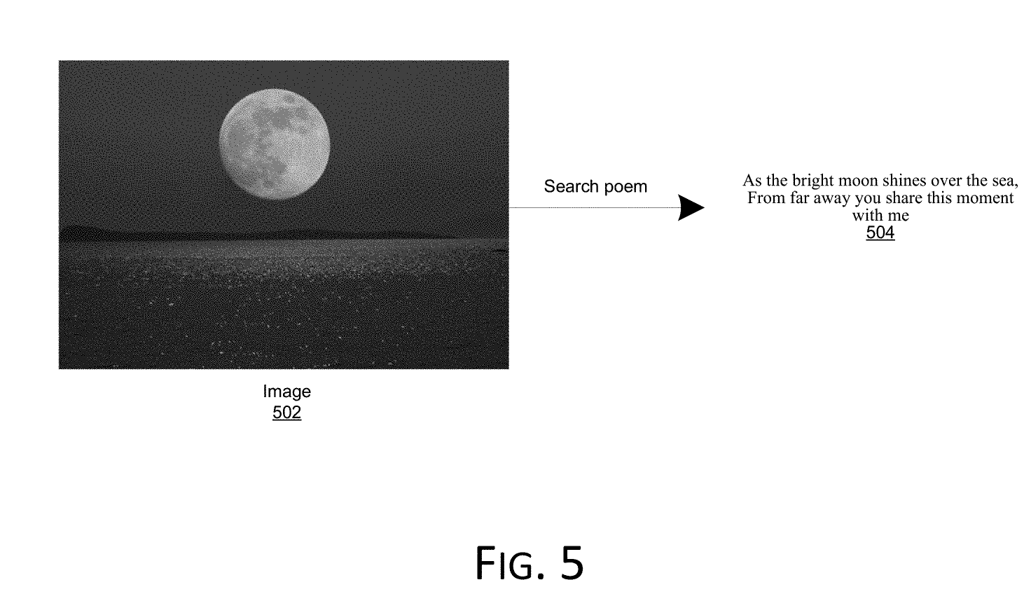

For example, as shown in FIG. 5, a matching poem needs to be found based on an image in some application or scenarios. After a user uploads an image 502, a matching poem may be found through search based on the image. In this case, by means of the above method, after the user uploads the image, an image feature vector of the uploaded image may be extracted, and then correlation calculation is performed on the extracted image feature vector and pre-extracted text feature vectors of a plurality of poems, so as to obtain a correlation between the image feature vector and the text feature vector of each poem. Then, the poem content corresponding to the uploaded image is determined based on the values of the correlations. The content of the poem or information such as the title or author of the poem may be presented. In the example of FIG. 5, the image feature vectors represent moon and ocean. The corresponding poem is searched and an example matching poem is “As the bright moon shines over the sea, from far away you share this moment with me,” 504 as shown in FIG. 5, which is a famous ancient Chinese poem.

Descriptions are given above by using four scenarios as examples. In actual implementation manners, the method may also be applied to other scenarios, as long as an image coding model and a text coding model conforming to the corresponding scenario may be obtained by extracting image tag pairs of the scenario and performing training.

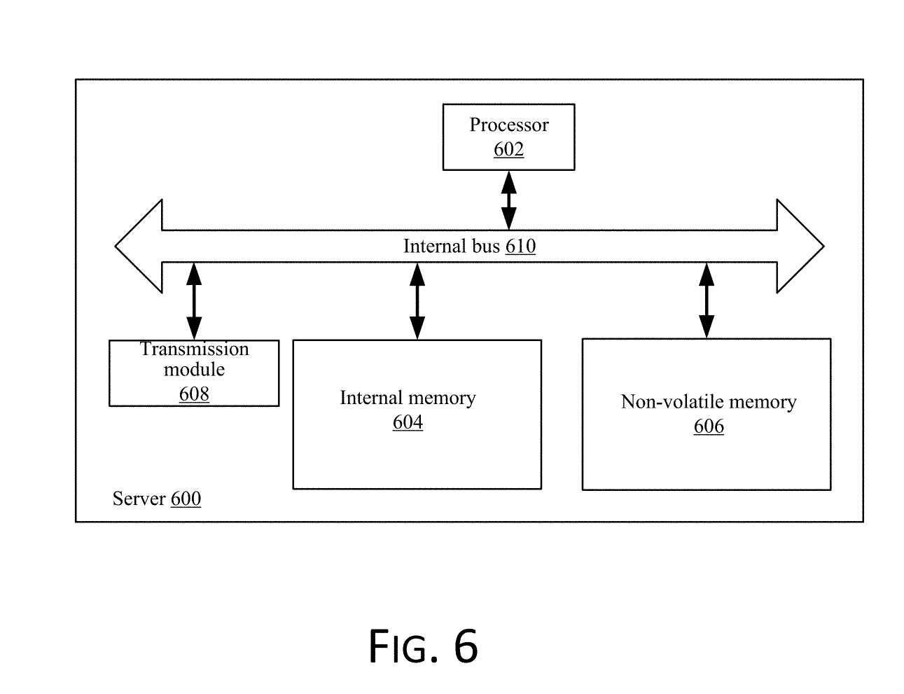

The method example embodiment provided in the example embodiments of the present disclosure may be executed in a mobile terminal, a computer terminal, a server or other similar computing apparatus. Using running on a server as an example, FIG. 6 is a structural block diagram of hardware of a server for a search method according to an example embodiment of the present disclosure. As shown in FIG. 6, a server 600 may include one or more (only one is shown) processors 602 (where the processor 602 may include, but is not limited to, processing apparatus such as a micro controller unit (MCU) or programmable logic device FPGA), computer readable media configured to store data including internal memory 604 and non-volatile memory 606, and a transmission module 608 configured to provide a communication function. The processor 602, the internal memory 604, the non-volatile memory 606, and the transmission module 608 are connected via internal bus 610.

It should be understood by those of ordinary skill in the art that the structure shown in FIG. 6 is merely schematic and does not constitute any limitation to the structure of the above electronic apparatus. For example, the server 600 may include more or fewer components than those shown in FIG. 6 or may have a configuration different from that shown in FIG. 6.

The computer readable media may be configured to store a software program and module of application software, for example, program instructions and modules corresponding to the search method in the example embodiments of the present disclosure. The processor 602 runs the software program and module stored in the computer readable media to execute various functional applications and data processing, that is, implement the above search method. The computer readable media may include a high-speed random access memory, and may also include a non-volatile memory such as one or more magnetic storage devices, flash memory, or other non-volatile solid state memory. In some examples, the computer readable media may further include memories remotely disposed relative to the processor 602. The remote memories may be connected to the server 600 through a network. Examples of the network include, but are not limited to, the Internet, an enterprise intranet, a local area network, a mobile communication networks, and combinations thereof.

The transmission module 608 is configured to receive or send data through a network. Specific examples of the network may include a wireless network provided by a communication provider. In an example, the transmission module 608 includes a Network Interface Controller (NIC), which may be connected to other network devices through a base station so as to communicate with the Internet. In an example, the transmission module 608 may be a Radio Frequency (RF) module configured to wirelessly communicate with the Internet.

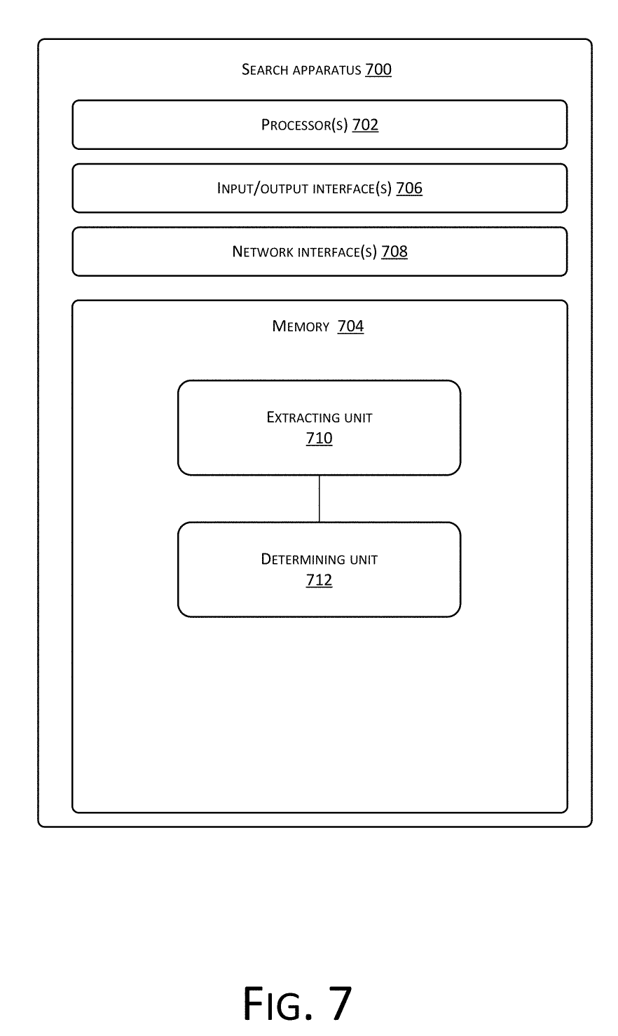

Referring to FIG. 7, a search apparatus 700 located at the server is provided. The search apparatus 700 includes one or more processor(s) 702 or data processing unit(s) and memory 704. The apparatus 700 may further include one or more input/output interface(s) 706 and one or more network interface(s) 708.

The memory 704 is an example of computer readable medium. The computer readable medium includes non-volatile and volatile media as well as movable and non-movable media, and may implement information storage by means of any method or technology. Information may be a computer readable instruction, a data structure, and a module of a program or other data. A storage medium of a computer includes, for example, but is not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storages, a cassette tape, a magnetic tape/magnetic disk storage or other magnetic storage devices, or any other non-transmission media, and may be used to store information accessible to the computing device. According to the definition in this text, the computer readable medium does not include transitory media, such as modulated data signals and carriers.

The memory 704 may store therein a plurality of modules or units including an extracting unit 710 and a determining unit 712.

The extracting unit 710 is configured to extract an image feature vector of a target image, wherein the image feature vector is used for representing image content of the target image.

The determining unit 712 is configured to determine, in the same vector space, a tag corresponding to the target image according to a correlation between the image feature vector and a text feature vector of the tag, wherein the text feature vector is used for representing semantics of the tag.

In an implementation manner, before determining the tag corresponding to the target image according to the correlation between the image feature vector and the text feature vector of the tag, the determining unit 712 may further be configured to determine a correlation between the target image and the tag according to a Euclidean distance between the image feature vector and the text feature vector.

In an implementation manner, the determining unit 712 may be configured to: use one or more tags as tags corresponding to the target image, wherein a correlation between a text feature vector of each of the one or more tags and the image feature vector of the target image is greater than a preset threshold; or use a predetermined number of tags as tags of the target image, wherein correlations between text feature vectors of the predetermined number of tags and the image feature vector of the target image rank on the top.

In an implementation manner, the determining unit 712 may be configured to: determine one by one a correlation between the image feature vector and a text feature vector of each of a plurality of tags; and after determining a similarity between the image feature vector and the text feature vector of each of the plurality of tags, determine the tag corresponding to the target image based on the determined similarity between the image feature vector and the text feature vector of each of the plurality of tags.

In an implementation manner, before extracting the image feature vector of the target image, the extracting unit 710 may further be configured to: acquire search click behavior data, wherein the search click behavior data includes search texts and image data clicked based on the search texts; convert the search click behavior data into a plurality of image tag pairs; and perform training according to the plurality of image tag pairs to obtain a data model for extracting image feature vectors and text feature vectors.

In an implementation manner, the converting the search click behavior data into a plurality of image tag pairs may include: performing segmentation processing and part-of-speech analysis on the search texts; determining tags from data obtained through the segmentation processing and the part-of-speech analysis; performing deduplication processing on the image data clicked based on the search texts; and establishing image tag pairs according to the determined tags and image data that is obtained after the deduplication processing.

The image tag determining method and the processing device provided by the present disclosure consider that a manner of searching for a text based on an image may be used, to directly search for and determine recommended texts based on an input target image without adding an image matching operation during matching, and directly obtain, through matching, a corresponding tag text according to a correlation between an image feature vector and a text feature vector. The method solves the problems of low efficiency and high requirements on the system processing capability in existing tag recommendation methods, thereby achieving a technical effect of easily and accurately implementing image tagging.

Although the present disclosure provides the operation steps of the method as described in the example embodiments or flowcharts, the method may include more or fewer operation steps based on conventional or non-creative efforts. The order of steps illustrated in the example embodiments is merely one of numerous step execution orders and does not represent a unique execution order. The steps, when executed in an actual apparatus or client terminal product, may be executed sequentially or executed in parallel (for example, in a parallel processor environment or multi-thread processing environment) according to the method shown in the example embodiment or the accompanying drawings.

Apparatuses or modules illustrated in the above example embodiments may be implemented by using a computer chip or entity or may be implemented using a product with certain functions. For the ease of description, the above apparatus is divided into different modules based on functions for description individually. In the implementation of the present disclosure, functions of various modules may be implemented in one or more pieces of software and/or hardware. Certainly, a module implementing certain functions may be implemented by a combination of a plurality of submodules or subunits.

The method, apparatus, or module described in the present disclosure may be implemented in the form of computer-readable program code. A controller may be implemented in any suitable manner. For example, the controller may take the form of a microprocessor or processor and a computer-readable medium that stores computer-readable program code (e.g., software or firmware) executable by the (micro)processor, logic gates, switches, an Application Specific Integrated Circuit (ASIC), a programmable logic controller, and an embedded microcontroller. Examples of controllers include, but are not limited to, the following microcontrollers: ARC 625D, Atmel AT91SAM, Microchip PIC18F26K20, and Silicone Labs C8051F320. The memory controller may also be implemented as part of the memory control logic. Those skilled in the art should know that other than realizing the controller by means of pure computer readable programming codes, logic programming may be performed for method steps to realize the same function of the controller in a form such as a logic gate, a switch, an application specific integrated circuit, a programmable logic controller, or an embedded microcontroller. Therefore, this type of controller may be regarded as a hardware component, and apparatuses included therein for realizing various functions may also be regarded as an internal structure of the hardware component. Even more, apparatuses for realizing various functions may be regarded as software modules for realizing the methods and the internal structure of the hardware component.

Some modules in the apparatus of the present disclosure may be described in the context of computer executable instructions, for example, program modules, that are executable by a computer. Generally, a program module includes a routine, a procedure, an object, a component, a data structure, etc., that executes a specific task or implements a specific abstract data type. The present disclosure may also be put into practice in a distributed computing environment. In such a distributed computing environment, a task is performed by a remote processing device that is connected via a communications network. In a distributed computing environment, program modules may be stored in local and remote computer storage media including storage devices.

According to the descriptions of the foregoing example embodiments, those skilled in the art may be clear that the present disclosure may be implemented by means of software and a necessary general hardware platform. Based on such an understanding, the technical solutions in the present disclosure essentially, or the part contributing to the prior art may be implemented in the form of a software product or may be embodied in a process of implementing data migration. The computer software product may be stored in a storage medium, such as a read-only memory (ROM), a random access memory (RAM), a magnetic disk, or an optical disc, and includes several instructions for instructing a computer device (which may be a personal computer, a mobile terminal, a server, a network device, or the like) to perform the method described in the example embodiments of the present disclosure or in some parts of the example embodiments of the present disclosure.

The example embodiments in the specification are described in a progressive manner. For same or similar parts in the example embodiments, reference may be made to each other. Each example embodiment focuses on differences from other example embodiments. The present disclosure is wholly or partly applicable in various general-purpose or special-purpose computer system environments or configurations, for example, a personal computer, a server computer, a handheld device or portable device, a tablet device, a mobile communication terminal, a multiprocessor system, a microprocessor-based system, programmable electronic equipment, a network PC, a small computer, a large computer, and a distributed computing environment including any of the foregoing systems or devices.

Although the present disclosure is described using the example embodiments, those of ordinary skill in the art shall know that various modifications and variations may be made to the present disclosure without departing from the spirit of the present disclosure, and it is intended that the appended claims encompass these modifications and variations without departing from the spirit of the present disclosure.

The present disclosure may further be understood with clauses as follows.

Clause 1. A search method, comprising:

extracting an image feature vector of a target image, wherein the image feature vector is used for representing image content of the target image; and

determining, in the same vector space, a text corresponding to the target image according to a correlation between the image feature vector and a text feature vector of the text, wherein the text feature vector is used for representing semantics of the text.

Clause 2. The method according to clause 1, wherein before the determining a text corresponding to the target image according to a correlation between the image feature vector and a text feature vector of the text, the method further comprises:

determining a correlation between the target image and the text according to a Euclidean distance between the image feature vector and the text feature vector.

Clause 3. The method according to clause 1, wherein the determining a text corresponding to the target image according to a correlation between the image feature vector and a text feature vector of the text comprises:

using one or more texts as texts corresponding to the target image, wherein a correlation between a text feature vector of each of the one or more texts and the image feature vector of the target image is greater than a preset threshold; or using a predetermined number of texts as texts of the target image, wherein correlations between text feature vectors of the predetermined number of texts and the image feature vector of the target image rank on the top.

Clause 4. The method according to clause 1, wherein the determining a text corresponding to the target image according to a correlation between the image feature vector and a text feature vector of the text comprises:

determining one by one a correlation between the image feature vector and a text feature vector of each of a plurality of texts; and

after determining a similarity between the image feature vector and the text feature vector of each of the plurality of texts, determining the text corresponding to the target image based on the determined similarity between the image feature vector and the text feature vector of each of the plurality of texts.

Clause 5. The method according to clause 1, wherein before the extracting an image feature vector of a target image, the method further comprises:

acquiring search click behavior data, wherein the search click behavior data comprises search texts and image data clicked based on the search texts;

converting the search click behavior data into a plurality of image text pairs; and

performing training according to the plurality of image text pairs to obtain a data model for extracting image feature vectors and text feature vectors.

Clause 6. The method according to clause 5, wherein the converting the search click behavior data into a plurality of image text pairs comprises:

performing segmentation processing and part-of-speech analysis on the search texts;

determining texts from data obtained through the segmentation processing and the part-of-speech analysis;

performing deduplication processing on the image data clicked based on the search texts; and

establishing image text pairs according to the determined texts and image data that is obtained after the deduplication processing.

Clause 7. The method according to clause 6, wherein the image text pair comprises a single-tag pair, and the single-tag pair carries one image and one text.

Clause 8. A processing device, comprising a processor and a memory configured to store an instruction executable by the processor, wherein when executing the instruction, the processor implements:

an image text determining method, the method comprising:

extracting an image feature vector of a target image, wherein the image feature vector is used for representing image content of the target image; and

determining, in the same vector space, a text corresponding to the target image according to a correlation between the image feature vector and a text feature vector of the text, wherein the text feature vector is used for representing semantics of the text.

Clause 9. The processing device according to clause 8, wherein before determining the text corresponding to the target image according to the correlation between the image feature vector and the text feature vector of the text, the processor is further configured to determine a correlation between the target image and the text according to a Euclidean distance between the image feature vector and the text feature vector.

Clause 10. The processing device according to clause 8, wherein the processor determining a text corresponding to the target image according to a correlation between the image feature vector and a text feature vector of the text comprises:

using one or more texts as texts corresponding to the target image, wherein a correlation between a text feature vector of each of the one or more texts and the image feature vector of the target image is greater than a preset threshold; or

using a predetermined number of texts as texts of the target image, wherein correlations between text feature vectors of the predetermined number of texts and the image feature vector of the target image rank on the top.

Clause 11. The processing device according to clause 8, wherein the processor determining a text corresponding to the target image according to a correlation between the image feature vector and a text feature vector of the text comprises:

determining one by one a correlation between the image feature vector and a text feature vector of each of a plurality of texts; and

after determining a similarity between the image feature vector and the text feature vector of each of the plurality of texts, determining the text corresponding to the target image based on the determined similarity between the image feature vector and the text feature vector of each of the plurality of texts.

Clause 12. The processing device according to clause 8, wherein before extracting the image feature vector of the target image, the processor is further configured to:

acquire search click behavior data, wherein the search click behavior data comprises search texts and image data clicked based on the search texts;

convert the search click behavior data into a plurality of image text pairs; and

perform training according to the plurality of image text pairs to obtain a data model for extracting image feature vectors and text feature vectors.

Clause 13. The processing device according to clause 12, wherein the processor converting the search click behavior data into a plurality of image text pairs comprises:

performing segmentation processing and part-of-speech analysis on the search texts;

determining texts from data obtained through the segmentation processing and the part-of-speech analysis;

performing deduplication processing on the image data clicked based on the search texts; and

establishing image text pairs according to the determined texts and image data that is obtained after the deduplication processing.

Clause 14. A search method, comprising:

extracting an image feature of a target image, wherein the image feature is used for representing image content of the target image; and

determining, in the same vector space, a text corresponding to the target image according to a correlation between the image feature and a text feature of the text, wherein the text feature is used for representing semantics of the text.

Clause 15. A computer readable storage medium storing a computer instruction, the instruction, when executed, implementing the steps of the method according to any one of clauses 1 to 7.

What is claimed is:

1. One or more computer readable media storing thereon computer-readable instructions that, when executed by one or more processors, cause the one or more processors to perform acts comprising:
acquiring search click behavior data, the search click behavior data including search texts and image data clicked based on the search texts;
converting the search click behavior data into a plurality of image text pairs, respective image text pair including a text and an image; and
performing training according to the plurality of image text pairs to obtain a data model for extracting an image feature vector and a text feature vector;
extracting an image feature vector of a target image, the image feature vector representing an image content of the target image; and
determining a text corresponding to the target image according to a correlation between the image feature vector and a text feature vector of the text, the text feature vector representing semantics of the text, the image feature vector and the text feature vector being in a same vector space.

2. A method comprising:
extracting an image feature vector of a target image, the image feature vector representing an image content of the target image; and
determining a text corresponding to the target image according to a correlation between the image feature vector and a text feature vector of the text, the text feature vector representing semantics of the text, the image feature vector and the text feature vector being in a same vector space.

3. The method of claim 2, further comprising:
determining the correlation between the target image and the text according to a Euclidean distance between the image feature vector and the text feature vector.

4. The method of claim 2, wherein the determining the text corresponding to the target image according to the correlation between the image feature vector and a text feature vector of the text includes:
selecting the text whose correlations between the text feature vector and the image feature vector of the target image is greater than a preset threshold.

5. The method of claim 2, wherein the determining the text corresponding to the target image according to the correlation between the image feature vector and a text feature vector of the text includes:
selecting the text whose correlations between the text feature vector and the image feature vector of the target image is greater than a preset ranking threshold.

6. The method of claim 2, wherein the determining the text corresponding to the target image according to the correlation between the image feature vector and the text feature vector of the text includes:
determining a respective similarity between the image feature vector and a respective text feature vector of a respective text among a plurality of texts; and
determining the text corresponding to the target image based on the determined respective similarity.

7. The method of claim 6, wherein the determining the respective similarity between the image feature vector and a respective text feature vector of a respective text among a plurality of texts includes:
determining, one by one, the respective similarity between the image feature vector and the respective text feature vector of each of the plurality of texts.

8. The method of claim 2, further comprising:
acquiring search click behavior data, the search click behavior data including search texts and image data clicked based on the search texts;
converting the search click behavior data into a plurality of image text pairs; and
performing training according to the plurality of image text pairs to obtain a data model for extracting the image feature vectors and the text feature vector.

9. The method of claim 8, wherein the converting the search click behavior data into the plurality of image text pairs includes:
performing segmentation processing and part-of-speech analysis on the search texts; and
determining texts from data obtained through the segmentation processing and the part-of-speech analysis.

10. The method of claim 9, wherein the converting the search click behavior data into the plurality of image text pairs further includes:
performing deduplication processing on image data clicked based on the search texts.

11. The method of claim 10, wherein the converting the search click behavior data into the plurality of image text pairs further includes:
establishing the plurality of image text pairs according to the determined texts and image data that is obtained after the deduplication processing.

12. The method of claim 8, wherein a respective image text pair of the plurality of image text pairs includes an image and a text.

13. An apparatus comprising:
one or more processors;
one or more computer readable media storing thereon computer-readable instructions that, when executed by one or more processors, cause the one or more processors to perform acts comprising:
extracting an image feature vector of a target image, the image feature vector representing an image content of the target image; and
determining a text corresponding to the target image according to a correlation between the image feature vector and a text feature vector of the text, the text feature vector representing semantics of the text, the image feature vector and the text feature vector being in a same vector space.

14. The apparatus of claim 13, wherein the acts further comprise:
determining the correlation between the target image and the text according to a Euclidean distance between the image feature vector and the text feature vector.

15. The apparatus of claim 13, wherein the determining the text corresponding to the target image according to the correlation between the image feature vector and a text feature vector of the text includes:
selecting the text whose correlations between the text feature vector and the image feature vector of the target image is greater than a preset threshold; or
selecting the text whose correlations between the text feature vector and the image feature vector of the target image is greater than a preset ranking threshold.

16. The apparatus of claim 13, wherein the determining the text corresponding to the target image according to the correlation between the image feature vector and the text feature vector of the text includes:
determining a respective similarity between the image feature vector and a respective text feature vector of a respective text among a plurality of texts; and
determining the text corresponding to the target image based on the determined respective similarity.

17. The apparatus of claim 16, wherein the determining the respective similarity between the image feature vector and a respective text feature vector of a respective text among a plurality of texts includes:
determining, one by one, the respective similarity between the image feature vector and the respective text feature vector of each of the plurality of texts.

18. The apparatus of claim 13, wherein the acts further comprise:
acquiring search click behavior data, the search click behavior data including search texts and image data clicked based on the search texts;
converting the search click behavior data into a plurality of image text pairs; and
performing training according to the plurality of image text pairs to obtain a data model for extracting the image feature vectors and the text feature vector.

19. The apparatus of claim 18, wherein the converting the search click behavior data into the plurality of image text pairs includes:
performing segmentation processing and part-of-speech analysis on the search texts;
determining texts from data obtained through the segmentation processing and the part-of-speech analysis;
performing deduplication processing on image data clicked based on the search texts; and
establishing the plurality of image text pairs according to the determined texts and image data that is obtained after the deduplication processing.

20. The apparatus of claim 18, wherein a respective image text pair of the plurality of image text pairs includes an image and a text.
